(19) United States
(12) Patent Application Publication
(10) Pub. No.: US 2015/0305238 A1
(43) Pub. Date: Oct. 29, 2015

(54) HARVESTER WITH SENSOR-BASED ADJUSTMENT OF AN OPERATING PARAMETER

(71) Applicant: Deere & Company, Moline, IL (US)

(72) Inventors: Martin Klausmann, Thaleischweiler-Froeschen (DE); Philipp Muench, Kaiserslautern (DE); Cristian Dima, St. Ingbert/Rohrbach (DE)

(21) Appl. No.: 14/686,936

(22) Filed: Apr. 15, 2015

(30) Foreign Application Priority Data
Apr. 29, 2014 (DE) 102014208068.1

(51) Int. Cl. A01D 41/127; A01D 75/00

(52) U.S. Cl. CPC A01D 41/127; A01D 75/00

(57) ABSTRACT

One or more sensors determine position data and detect a corresponding characteristic of field area with a crop stock located at a field side or sides next to the harvester. On a location-specific basis, the method stores the data on the characteristic detected or a crop parameter derived from the characteristic. On a predictive location-specific basis, the method retrieves the data on the characteristic stored or the stored crop parameter derived from the characteristic. During the harvesting of the field area detected with the sensor, the actuator is adjusted based on the characteristic or the crop parameter such that the operating parameter is adapted to the characteristic detected for the corresponding field area.

### RELATED APPLICATIONS

This document claims priority based on German Patent Application No. 102014208068.1, filed Apr. 29, 2014, which is hereby incorporated by reference into this document.

1. Field of the Invention

The invention relates to a method and an arrangement for automatically adjusting an actuator for influencing an operating parameter of a harvester that can move over a field in a forward direction during a harvesting process.

2. Background Art

In agricultural harvesters, the throughput is proportionally dependent on the respective forward drive speed of the harvester. To load the harvester as well as possible and to utilize it as efficiently as possible, systems are known that automatically adjust the forward speed in the sense of maintaining a desired crop throughput and unburdening the operator from the task of setting a speed. There is also the possibility of automatically adjusting other settings of the harvester (e.g., a parameter of a threshing or cleaning unit of a combine harvester) as a function of the throughput or other characteristics of the crop, such as, for example, its moisture content. The density and other characteristics of the crop can vary more or less strongly over a field, resulting in corresponding changes to the operating parameter to be adjusted in the harvester.

However, detecting the characteristic of the crop, especially first detecting it by means of a sensor on board the harvester (see, for example, German Patent Application No. DE 1 199 039 B), and adjusting the operating parameter as a result of a change in the crop characteristic, make the operation dependent on a certain amount of response time that has the result that the operating parameter is adjusted to a change in the sensed characteristic of the crop only with a certain amount of time delay. This is especially critical if the density increases very quickly and with a big change in amount, because this can lead to an overload or blockage in the harvester.

In the prior art, solutions were proposed in which a prediction is made for a characteristic of the crop on the field, and the settings for an operating parameter of the harvester are derived from this prediction such that the operating parameter of the harvester has already been adjusted to the value to be set when a certain position of the field is reached, whether it is by means of a map generated during a previous harvesting process, wherein the characteristics of the crop sensed at that time are recorded in this map (e.g., German Patent No. DE 44 31 824 C1), or a characteristic of the crop detected on an adjacent track (also German Patent No. DE 44 31 824 C1), or by means of a sensor with a predictive function (e.g., German Patent No. DE 101 30 665 A1).

Adjusting the operating parameter of the harvester based on a map recorded in a previous year has the disadvantage that the crop characteristics can change considerably in successive years, e.g., due to different weather conditions, so that the map-based adjustments are not always optimal. Analogously, adjacent tracks also do not always have identical crop characteristics. The adjustment of the operating parameter based on a predictive sensor requires a sensor that views the field far enough ahead over the harvesting attachment to allow an adjustment of the operating parameter in a sufficiently timely manner in view of the response times. The distance between the sensor and the area of the field detected by it lies on the order of magnitude of 10 m and above, and the angle at which the crop is sensed is very flat.

The effect of this arrangement on sensors with radar, laser, or camera operation is the following. If radar sensors are used, the radar beam interacts with air, the crop, and then the ground. The energy reflected back to the sensor through the many different media it has passed through is often combined in very complicated ways, which results in difficult signal processing for determining the crop characteristics. If a camera views the crop at a flat angle, it basically detects just the top side of the crop stock. Due to the large distance, the resolution measured in pixels/cm is very poor. A laser sensor has similar problems to a camera. Both the penetration depth of the laser beam and also the effective resolution decrease with distance and the flatness of the angle of incidence.

Consequently, at such large distances, with many sensors, good measurement accuracy cannot be achieved. In addition, the environment of the cutting tool of a combine harvester has a high dust load if the crop is very dry, which makes the detection of the crop characteristics more difficult with optical sensors.

It is indeed known to monitor the lateral environment of a harvester with an optical sensor (Japanese Patent App. No. JP 2005 151 871 A1). That Japanese patent document involves a camera that helps the driver of the harvester with steering in that the driver can use a monitor to detect rows of crop that have been driven over unintentionally by a crawler-mounted vehicle. Automatic adjustment of an operating parameter of the harvester is not provided.

Finally, it was proposed to mount a sensor on an aircraft that flies before the harvester and forwards detected characteristics of the crop to the harvester, whose operating parameters are controlled automatically based on output signals of the sensor (e.g., German Patent Application No. DE 10 2010 038 661 A1). This, however, requires an aircraft, which increases the expense.

### SUMMARY

In accordance with one embodiment, a method and arrangement are disclosed for automatically adjusting an actuator for influencing an operating parameter of a harvester. One or more sensors determine position data and detect a corresponding characteristic of field area with a crop stock located at a field side or sides next to the harvester. On a location-specific basis, the method or arrangement stores the data on the characteristic detected or a crop parameter derived from the characteristic. On a predictive location-specific basis, the method or arrangement retrieves the data on the characteristic stored or the stored crop parameter derived from the characteristic. During the harvesting of the field area detected with the sensor, the actuator is adjusted based on the characteristic or the crop parameter such that the operating parameter is adapted to the characteristic detected for the corresponding field area.

### BRIEF DESCRIPTION OF THE DRAWINGS

FIG. 1 illustrates a semi-schematic side view of an agricultural combine or harvester.

FIG. 2 is a top view of the combine or harvester of FIG. 1 while harvesting a field.

FIG. 3 is a flow chart that shows the operation of the control unit of the combine or harvester for determining and storing the sensor data.

FIG. 4 is a flow chart that shows the operation of the control unit of the combine or harvester for adjusting the operating parameters of the actuators.

### DETAILED DESCRIPTION OF ILLUSTRATIVE EMBODIMENT(S)

The present disclosure is well suited for improving a harvester equipped with a sensor to detect crop characteristics.

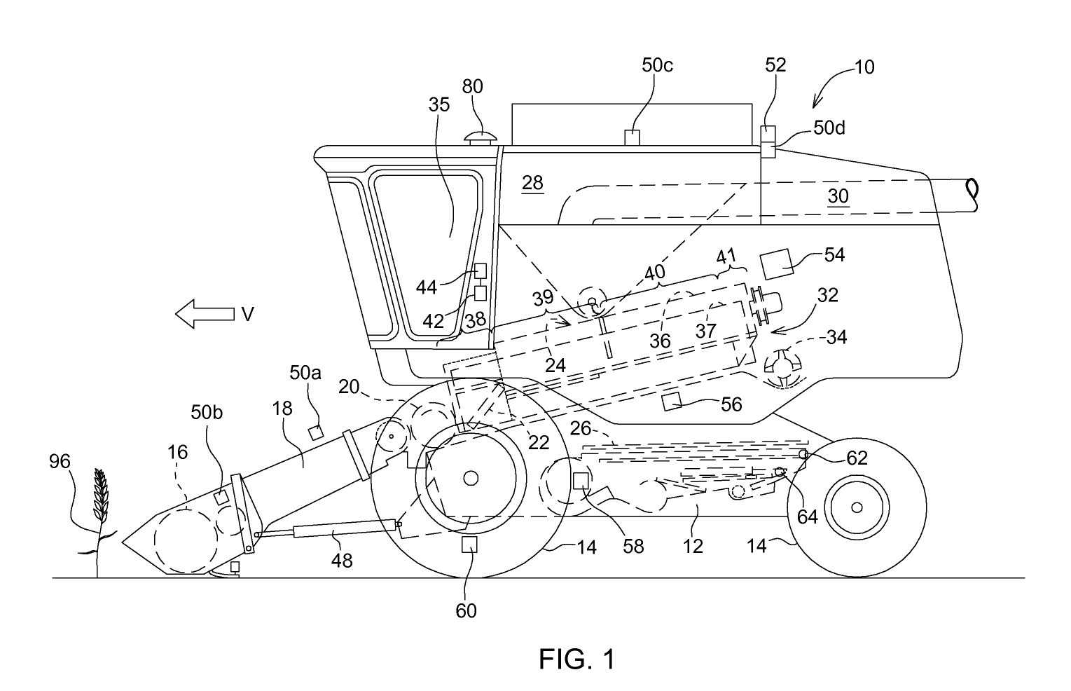

In accordance with one embodiment, FIG. 1 illustrates a method and arrangement for automatically adjusting an actuator (48, 54, 56, 58, 60, 62, 64) for influencing an operating parameter of a harvester 10. One or more sensors (50a, 50b, 50c, 50d) determine position data and detect a corresponding characteristic of field area with a crop stock (96a) located at a field side or sides next to the harvester 10. On a location-specific basis, the control unit 42 stores in memory 44 the data on the characteristic detected or a crop parameter derived from the characteristic. On a predictive location-specific basis, the control unit 42 retrieves or reads the data from memory 44 on the characteristic stored or the stored crop parameter derived from the characteristic. During the harvesting of the field area detected with one or more sensors (50a, 50b, 50c, 50d), the control unit 42 adjusts or sets the actuator (48, 54, 56, 58, 60, 62, 64) is based on the characteristic or the crop parameter such that the operating parameter is adapted to the characteristic detected for the corresponding field area or crop stock 96a.

In other words, during the ongoing harvesting process, the crop stock at the side next to the harvester is examined with the sensor mounted on the harvester in order to determine a characteristic of the crop, for example, the crop height, crop density, moisture content, and/or the ground profile (topography) on which the crop stock is standing. This characteristic (or a parameter derived from this characteristic) is stored in a location-specific manner. At a later time, if the harvester is then located directly in front of the position at which the characteristic was determined, then the characteristic (or the parameter derived from this characteristic) is retrieved from the memory in a timely manner and an operating parameter of the actuator is defined using this characteristic as a reference. In this way, it is achieved that the operating parameter is adapted exactly to the characteristic when the crop stock whose characteristic was determined with the sensor is harvested. Thus the performance of the harvester (throughput) and/or another operating parameter, such as the grain loss and/or the cracked grain fraction and/or the straw quality, can be optimized.

In this way, with simple means, one can nevertheless achieve a precise adjustment of the operating parameter of the harvester to the characteristic of the crop stock. The sensing of the crop stock to the side of the harvester has the advantage that the distance between the sensor and the crop stock can be shorter than that for sensing of the crop stock in front of the harvester, and there is a smaller dust load there. Consequently, more precise measurement values can be obtained there. Because the mentioned characteristic of the crop was already detected during a previous drive over the field, the adjustment data for the actuator is available with high accuracy far in advance of the areas of the field in front of the machine. The data is provided early enough that even very slowly adjustable actuators can be adjusted in a timely manner. The sensor is, in particular, an optoelectronic sensor with contactless operation, e.g., a camera, a laser scanner, or a radar sensor.

The actuator can be designed for adjusting the forward drive speed of the harvester and/or for adjusting a crop processing parameter of the harvester (in a combine harvester, for example, for adjusting a threshing parameter, such as threshing gap and/or rotational speed of the thresher, or a cleaning parameter, such as the rotational speed of a blower and/or screen opening) and/or for adjusting the operating height of a harvesting attachment.

The sensor can be mounted directly on the supporting structure of the harvester or on a harvesting attachment connected to the harvester or on an extension arm mounted on the harvester. The sensor can view the crop stock from above at a right angle or an oblique angle. An arrangement for automatically adjusting an actuator for influencing an operating parameter of a harvester that can move over a field in a forward direction during a harvesting process is equipped, according to all of this, with the following:

(a) a sensor that is mounted on the harvester and is designed to detect at least one characteristic of an area of the field with a crop stock located at the side next to the harvester,

(b) a memory connected to a position determining device for the location-specific storage of the characteristic detected with the sensor and/or a parameter derived from this characteristic, and

(c) a control unit connected to the position determining device for the predictive location-specific retrieval of the characteristic stored in the memory and/or the parameter derived from this characteristic and for the adjustment of the actuator based on this characteristic or parameter such that, during the harvesting of the crop stock, the operating parameter is adapted to the characteristic detected with the sensor.

The arrangement according to the invention can be used in self-propelled harvesters or harvesters pulled by a vehicle or mounted on a vehicle, for example, combine harvesters, or self-propelled balers or field choppers.

In the case of a harvester pulled by a tractor vehicle or mounted on a tractor vehicle, such as a baler or a field chopper, the speed of the harvester is controlled by monitoring the driving speed of the tractor vehicle. For this purpose, a control unit of the harvester can communicate with a controller of the tractor vehicle via a bus. The sensor can be fastened to the harvester and/or the tractor vehicle. The setting of the driving speed of the tractor vehicle can be performed by the control unit of the harvester and/or the tractor vehicle. Consequently, for a combination of a tractor vehicle and a pulled or mounted harvester, the whole combination can be considered as the harvester in the sense of the present protective rights.

FIG. 1 shows an agricultural combine harvester 10 used as an example for a harvester with a supporting structure 12 that is provided with wheels 14 that are in contact with the ground. Although a combine harvester 10 is shown with wheels, it could also be provided with two or four track drives. A cutting tool 16 is used for harvesting the crop and feeds it to a slope conveyor 18. The slope conveyor 18 includes a conveying device to feed the harvested goods to a guide drum 20. The guide drum 20 feeds the goods upward through an inlet transition section 22 and to a rotating threshing and separating device 24 designed for threshing and separating. The shown threshing and separating device 24 is arranged axially in the combine harvester, but it could also be arranged in a different orientation relative to the longitudinal axis of the combine harvester 10, in particular, in the transverse direction. Although the present invention is described using a threshing and separating device 24 with a rotor, it could also be used in a combine harvester 10 with a conventional, transversely arranged threshing drum that interacts with a threshing basket with a downstream separating device in the form of an axial or tangential separating rotor and/or straw shaker. Instead of a combine harvester 10, the invention could also be used on a field chopper or a towed or self-propelled baler.

The threshing and separating device 24 threshes and separates the harvested goods. The grain and the chaff fall through gratings at the bottom of the threshing and separating device 24 into a cleaning system 26. The cleaning system 26 removes the chaff and feeds the clean grain to a (not shown) elevator for clean grain. The elevator for clean grain places the grain into a grain tank 28. The clean grain in the grain tank 28 can be fed through an unloading screw conveyor 30 to a truck or trailer.

Threshed straw freed from the grain is fed from the threshing and separating device 24 through an outlet 32 to a discharge drum 34. The discharge drum 34 ejects the straw back to the rear side of the combine harvester 10. It is to be noted that the discharge drum 34 could also feed the goods freed from the grain directly to a straw chopper. The operation of the combine harvester 10 is controlled from a control cabin 35.

The threshing and separating device 24 comprises a cylindrical rotor housing 36 and a rotating rotor 37 arranged in the rotor housing 36. The front part of the rotor 37 and the rotor housing 36 define a loading section 38. Downstream of the loading section 38 are the threshing section 39, separating section 40, and discharge section 41. The rotor 37 is provided in the loading section 38 with a conical rotor drum that has spiral-shaped loading elements for interacting with the goods that it obtains from the guide drum 20 and from the inlet transition area 22. Directly downstream of the loading section 38 is the threshing section 39. In the threshing section 39, the rotor 37 has a cylindrical rotor drum that is provided with a number of threshing elements in order to thresh the goods received from the loading section 38. Downstream of the threshing section 39 is the separating section 40, in which the grain still contained in the threshed goods is released and falls through the bottom grating in the rotor housing 36 into the cleaning system 26. The separating section 40 transitions into the outlet section 41 in which the material (straw) freed from the grain is ejected from the threshing and separating device 24.

The combine or harvester is equipped with a control unit 42 that is used to control the operating parameters of several actuators. These actuators include an actuator 60 for setting the forward drive speed that controls the coupling ratio of a hydrostatic transmission (not shown) that is used to drive the front wheels 14. Another actuator 48 controls the operating height of the cutting tool 16. Other actuators could control operating parameters of the threshing and separating device 24, such as an actuator 54 controlling its rotational speed and an actuator 56 controlling its threshing gap, and operating parameters of the cleaning system 26, such as an actuator 58 setting the rotational speed of a cleaning blower and the actuators 62, 64 controlling the opening parameter of screens.

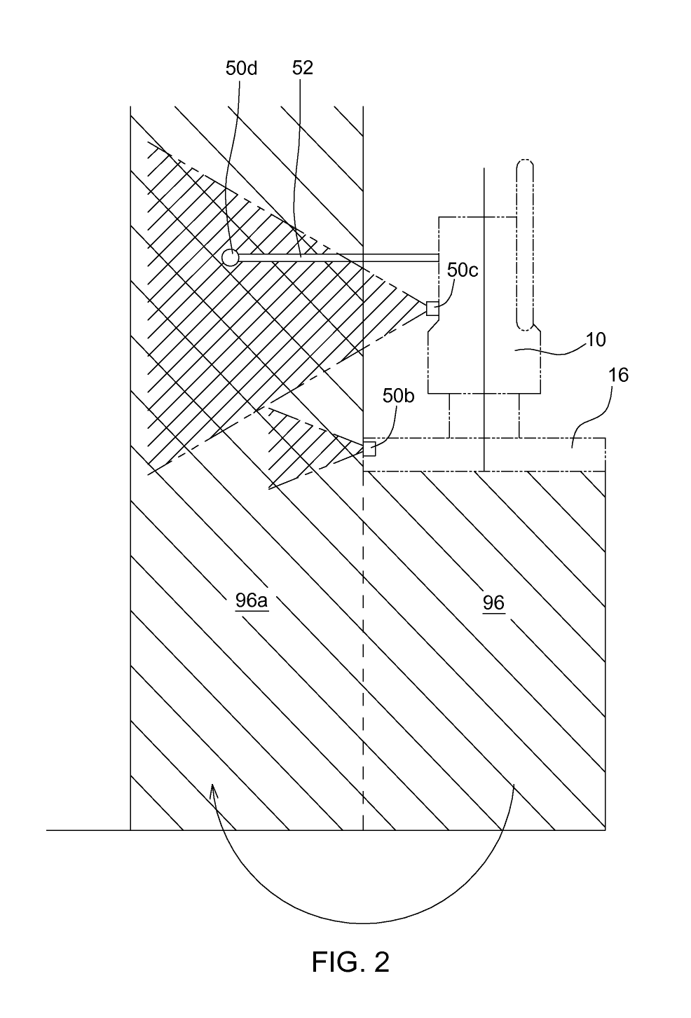

The control of at least one of the mentioned operating parameters by the control unit 42 is based on at least one sensor 50a, 50b, 50c, 50d that detects characteristics of the crop stock 96a that is located laterally next to the combine harvester 10 with respect to the forward direction V of the combine harvester 10, as shown in the drawing in FIG. 2. The sensor 50a is mounted laterally on the top side of the slope conveyor 18 and looks from there horizontally or diagonally downward onto the crop stock 96a. The sensor 50b is mounted laterally on the outer end of the cutting tool 16 and looks from there horizontally or diagonally downward onto the crop stock 96a. The sensor 50c is mounted on the top side of the supporting structure 12 of the combine harvester 10 on the lower edge of the grain tank attachment and looks from there at an angle downward onto the crop stock 96a. The sensor 50d is mounted on an extension arm 52 that is fastened at the back of the grain tank 28 on the top side on the supporting structure 12 and is located approximately in the center of the strip of the crop stock 96a that is harvested by the combine harvester 10 in a subsequent drive over the field. It looks vertically downward onto the crop stock 96a. The extension arm 52 can have a telescoping and/or pivoting design, in order to move the sensor 50d when not in use into a stowed transport position. The shown mounting options for the sensors 50a to 50d are only examples; the sensors could also be mounted on other locations of the combine harvester 10. It is also usually sufficient if only one of the shown sensors 50a to 50d is present.

The sensors 50a to 50d can be of any type. In particular, they can be known scanning radars or laser range finders or cameras. During operation, they detect at least one characteristic of the crop stock 96a, such as crop density, crop height, and/or moisture content and/or weed infestation. In addition, environmental conditions such as ground topography and/or obstacles can be detected. Using this characteristic, the control unit 42 connected to the sensors 50a to 50d can derive operating parameters adapted to this characteristic for the mentioned actuators 48, 54, 56, 58, 60, 62, 64. For a reference hereto and on the configuration of the sensors 50a to 50d, see the prior art according to the following German Patent Applicantion Nos. DE 101 30 665 A1, DE 10 2008 043 716 A1, DE 10 2011 017 621 A1 and DE 10 2011 085 380 A1, which are incorporated in the present document through this reference.

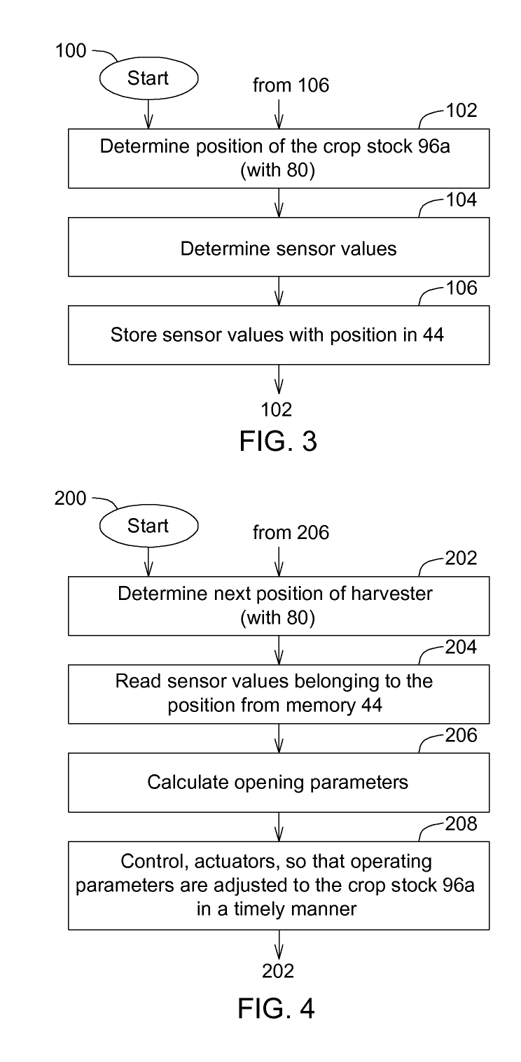

During the harvesting process, the control unit 42 stores the sensor data according to the flow chart of FIG. 3. After the start in step 100, in step 102, the position is determined for the respective crop stock 96 that is detected with the sensors 50a to 50d and is next to the combine harvester 10. For this purpose, a position determining system 80 is used that receives signals from satellites (e.g., GPS, Glonass, and/or Galileo) and optionally terrestrial transmitters for improving the accuracy, and derives the position from these signals. The forward drive direction of the combine harvester 10 can be determined from subsequently detected position data and/or signals from the satellites and/or inertial navigation sensors and/or sensors interacting with the wheels. The detected position of the position determining system 80 is then transformed into the position of the crop stock 96 that is detected with the sensors 50a to 50d and is next to the combine harvester 10. For a reference hereto, see the prior art according to U.S. Pat. No. 5,987,371 A and German Patent Application No. DE 198 30 858 A1.

If one or more of the sensors 50a to 50d are adjustable (especially displaceable, like the sensor 50d, or pivotable about an axis running in the forward direction), in order to be able to adapt their sensitive area automatically or through operator input or adjustment to the operating width of the cutting tool 16, the position of the sensitive area of the adjustable sensor 50a to 50d is input manually or automatically by means of an associated detection means into the control unit 42 and taken into account in step 102.

In the next step 102, the sensor values are then determined, i.e., signals are obtained from one or more of the sensors 50a to 50d and stored in the following step 106 together with the position data in a memory 44. Here, the sensor signals or parameters derived from these signals can be stored directly. If the sensor 50d detects, for example, the propagation time of electromagnetic waves to the crop and to the ground surface, the height of the crop stock above the ground can be derived from the propagation times. After step 106, step 102 follows again.

FIG. 4 shows the procedure of the control unit 42 when setting the operating parameter of one or more of actuators 48, 54, 56, 58, 60, 62, 64. The control unit 42 performs both processes, i.e., the storage of the sensor data according to FIG. 3 and the setting of the operating parameter of the actuators 48, 54, 56, 58, 60, 62, 64 according to FIG. 4, alternately in sufficiently short time intervals, but almost at the same time, or in parallel with each other. It would also be conceivable to divide the control unit 42 into two parts, with one performing the tasks of FIG. 3 and the other performing the tasks of FIG. 4.

After the start in step 200 of FIG. 4, the control unit 42 determines, in step 202, at what position the combine harvester 10 will be located next, i.e., after expiration of a time Δt. This time At is dimensioned such that the time that the control unit requires for steps 204 to 208 and the time that the actuators 48, 54, 56, 58, 60, 62, 64 require for adjusting the new operating parameter at least approximately match. Step 202 is processed analogously to step 102, but the position of the crop stock 96 to be determined does not lie next to the combine harvester 10 (as in step 102), but instead in front of the combine harvester 10 (compare to FIG. 1).

In the following step 204, the control unit reads the values of the sensors 50a to 50d belonging to the position determined in step 202 (or the stored parameter derived from these values) from the memory 44 and then calculates, in step 206, operating parameters adapted to the sensor values for the actuators 48, 54, 56, 58, 60, 62, 64. In step 204, other values can also be considered that are obtained by non-depicted sensors locally on board the combine harvester 10, such as current crop characteristics (e.g., moisture content and/or throughput values), actual positions of the actuators 48, 54, 56, 58, 60, 62, 64 and/or stored calibration data for the sensors 50a to 50d.

In step 208, the control unit 42 then controls one or more of the actuators 48, 54, 56, 58, 60, 62, 64 corresponding to the results of step 206. Then, step 202 follows again. By sensing the crop stock 96a next to the combine harvester 10 and the later use of the sensor data for the automatic adjustment of at least one operating parameter of an actuator of the combine harvester 10, the disadvantages of previous sensors that looked forward from the combine harvester onto the crop stock 96 can be avoided. In particular, the distance between the sensors 50a to 50d and the monitored crop stock 96a is smaller, the angle can be significantly steeper, and there is a lower dust load at the sensed location.

Different modifications of the shown embodiment can be conceived. For example, the control unit 42, instead of the actuators 48, 54, 56, 58, 60, 62, 64, could have an automatic operation to display appropriate information to the operator in the cabin 35, who then manually triggers the adjustment of the actuators 48, 54, 56, 58, 60, 62, 64 through the use of input means. In addition, the strip of the field with the crop stock 96a sensed according to FIG. 3 does not have to be harvested directly after the harvesting of the adjacent crop stock 96 from which the crop stock 96a was sensed (cf. FIG. 2), but instead can be harvested at a later time if, e.g., for simplifying the turnaround process in the headland, the next strip over or a different strip is harvested first, or if the field is harvested in a spiral pattern. The sensors 50a to 50d of FIG. 1 look only to the right. It would also be possible that all of the sensors 50a to 50d look to the left, or the sensors 50a to 50d are arranged on both sides of the combine harvester 10.

Having described on or more embodiments, it will become apparant that various modifications can be made without departing from the scope of the invention as defined in the accompanying claims. Further embodiments of th invention may include any combination of features from one or more dependent claims, and such features may be incorporated, collectively or separately, into any independent claim.

1. A method for automatically adjusting an actuator for influencing an operating parameter of a harvester that can move over a field in a forward direction during a harvesting process, the method comprising the following steps:
(a) detecting at least one characteristic of an area of the field with a crop stock located at a field side or sides next to the harvester, the detecting accomplished by means of a sensor mounted on the harvester;
(b) on a location-specific basis, storing the at least one characteristic detected in step (a) or a crop parameter derived from the characteristic;
(c) on a predictive location basis, retrieving the at least one characteristic stored in step (b) or the stored crop parameter derived from the characteristic; and
(d) adjusting the actuator based on the characteristic or the crop parameter such that the operating parameter is adapted during the harvesting of the area of the field detected with the sensor in step (a) to the characteristic detected in step (a).

2. The method according to claim 1, wherein the sensor comprises an optoelectronic sensor with contactless operation, such as a camera, a laser scanner, or a radar sensor.

3. The method according to claim 1, wherein the actuator is designed for adjusting the forward speed of the harvester, or for adjusting a crop processing parameter of the harvester, or for adjusting the operating height of a harvesting attachment.

4. The method according to claim 1, wherein the sensor is mounted on the harvester, or on a harvesting attachment, or on an extension arm attached to the harvester.

5. The method according to claim 1, wherein the sensor has a viewing angle onto the crop stock at a right angle from above or at an oblique angle from above.

6. The method according to claim 1, wherein the sensor detects a height or density of the crop stock, or its moisture content, or a ground topography of the field.

7. An arrangement for automatically adjusting an actuator for influencing an operating parameter of a harvester that can move over a field in a forward direction during a harvesting process, the arrangement comprising:
(a) a sensor that is mounted on the harvester and is designed to detect at least one characteristic of an area of the field with a crop stock located at the side next to the harvester,
(b) a memory connected to a position determining device for storage, on a location-specific basis, of the characteristic detected with the sensor or a parameter derived from this characteristic, and
(c) a control unit connected to the position determining device for the predictive location-specific retrieval of the characteristic stored in the memory and/or the parameter derived from this characteristic and for the adjustment of the actuator based on this characteristic or parameter such that the operating parameter is adapted during the harvesting of the crop stock to the characteristic detected with the sensor.

8. A harvester comprising:
an actuator for influencing an operating parameter of a harvester;
a sensor that is mounted on the harvester and is designed to detect at least one characteristic of an area of the field with a crop stock located at the side next to the harvester,
a memory connected to a position determining device for storage, on a location-specific basis, of the characteristic detected with the sensor or a parameter derived from this characteristic, and
a control unit connected to the position determining device for the predictive location-specific retrieval of the characteristic stored in the memory and/or the parameter derived from this characteristic and for the adjustment of the actuator based on this characteristic or parameter such that the operating parameter is adapted during the harvesting of the crop stock to the characteristic detected with the sensor.

9. The method according to claim 1 wherein the actuator is designed for adjusting the forward speed of the harvester and for adjusting a crop processing parameter of the harvester, or for adjusting the operating height of a harvesting attachment.
